(19) United States
(12) Patent Application Publication
(10) Pub. No.: US 2021/0380774 A1
(43) Pub. Date: Dec. 9, 2021

(54) PRODUCTION OF POLYURETHANE FOAM

(71) Applicant: Evonik Operations GmbH, Essen (DE)

(72) Inventors: Michael Wagner, Recklinghausen (DE); Peter Altenbuchner, Münster (DE)

(73) Assignee: Evonik Operations GmbH, Essen (DE)

(21) Appl. No.: 17/239,087

(22) Filed: Apr. 23, 2021

(30) Foreign Application Priority Data
Jun. 4, 2020 (EP) 20178243.0

(51) Int. Cl. C08J 9/00; C08G 18/16; C08G 18/12; C08G 18/48; C08G 18/63; C08G 18/76; C08G 81/02; C08G 63/08; C08F 236/06

(52) U.S. Cl. CPC C08J 9/0061; C08G 18/16; C08G 18/12; C08G 18/48; C08G 18/631; C08G 18/7657; C08G 2101/00; C08G 63/08; C08F 236/06; C08J 2205/10; C08J 2375/06; C08G 2110/0025; C08G 81/027

(57) ABSTRACT

What are described are compositions for production of polyurethane foam, comprising at least an isocyanate component, a polyol component, optionally a catalyst that catalyzes the formation of a urethane or isocyanurate bond, optionally blowing agent, wherein the composition comprises block copolymers based on OH- or amino-functionalized polyolefins and polyesters that act as foam stabilizer.

### CROSS REFERENCE TO RELATED APPLICATIONS

This application is a 35 U.S.C. § 119 patent application which claims the benefit of European Application No. 20178243.0 filed Jun. 4, 2020, which is incorporated herein by reference in its entirety.

### FIELD

The present invention is in the field of polyurethane foams. It especially relates to the production of rigid polyurethane foams using block copolymers based on OH- or amino-functionalized polyolefins and polyesters that act as foam stabilizer. It further relates to corresponding compositions, and to the use of the foams that have been produced in accordance with the invention. The polyurethane foams are especially rigid polyurethane foams.

### BACKGROUND

Polyurethane (PU) in the context of the present invention is especially understood as meaning a product obtainable by reaction of polyisocyanates and polyols or compounds having isocyanate-reactive groups. Further functional groups in addition to the polyurethane may also be formed in the reaction, examples being uretdiones, carbodiimides, isocyanurates, allophanates, biurets, ureas and/or uretonimines. Therefore, PU is understood for the purposes of the present invention as meaning not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is understood as meaning foam that is obtained as reaction product based on polyisocyanates and polyols or compounds having isocyanate-reactive groups. In addition to the eponymous polyurethane, further functional groups can be formed as well, examples being allophanates, biurets, ureas, carbodiimides, uretdiones, isocyanurates or uretonimines. The most preferred foams in the context of the present invention are rigid polyurethane foams.

Polyurethane and polyisocyanurate foams, especially corresponding rigid foams, are produced using cell-stabilizing additives to ensure a fine-celled, uniform and low-defect foam structure and hence to exert an essentially positive influence on the performance characteristics, for example the thermal insulation performance in particular, of the rigid foam. Surfactants based on polyether-modified siloxanes are particularly effective and therefore represent the preferred type of foam stabilizers.

Various publications relating to the use of siloxane-based additives have already been published. Usually, polyethersiloxane foam stabilizers (PES) are used here.

EP 0 570 174 B1 describes polyethersiloxanes suitable for the production of rigid polyurethane foams using organic blowing agents, particularly chlorofluorocarbons such as CFC-11.

EP 0 533 202 A1 describes polyethersiloxanes that bear SiC-bonded polyalkylene oxide radicals and are suitable as blowing agent in the case of use of hydrochlorofluorocarbons, for example HCFC-123.

EP 0 877 045 B1 describes analogous structures for this production process which differ from the former foam stabilizers in that they have a comparatively higher molecular weight and have a combination of two polyether substituents on the siloxane chain.

EP1544235 describes typical polyether-modified siloxanes for rigid PU foam applications. Siloxanes having 60 to 130 silicon atoms and different polyether substituents R, the mixed molar mass of which is 450 to 1000 g/mol and the ethylene oxide content of which is 70 to 100 mol %, are used here.

CN103055759 describes polyether-modified siloxanes that bring about improved cell opening. At least 18 silicon units are present in the siloxane, and various types of side chains are used for modification.

EP 1873209 describes polyether-modified siloxanes for production of rigid PU foams having improved fire properties. Here there are 10 to 45 silicon atoms in the siloxanes, and the polyether side chains consist to an extent of at least 90% of ethylene oxide units.

EP 2465891 A1 describes polyether-modified siloxanes in which some of the polyether side chains bear OH groups. The siloxanes here contain at least 10 silicon atoms.

EP 2465892 A1 describes polyether-modified siloxanes in which the polyether side chains bear mainly secondary OH end groups, where the siloxanes here too contain at least 10 silicon atoms.

DE 3234462 describes siloxanes for use in flexible foam, especially moulded flexible foam. There are descriptions here of combinations of polyether-modified siloxanes (PES) and polydimethylsiloxanes, where the PES contain 4 to 15 silicon units.

Nevertheless, there is still a need for further cell stabilizers for PU foam, preferably for rigid PU foam, and especially for those cell stabilizers that fundamentally enable siloxane-free cell stabilization.

### SUMMARY

The specific object of the present invention was thus to enable the provision of PU foams, especially rigid PU foams, wherein it is fundamentally possible to achieve siloxane-free cell stabilization.

It has been found that, surprisingly, when block copolymers based on OH- or amine-functionalized polyolefins and polyesters are used as foam stabilizer, it is possible to produce PU foams, especially rigid PU foams, in impeccable quality. The block copolymers according to the invention fundamentally enable siloxane-free cell stabilization, i.e. make it possible to dispense entirely with siloxane-based additives, for example the known polyethersiloxane foam stabilizers. However, they also permit joint use with the siloxane-containing stabilizers known from the prior art. Both are encompassed by the present invention.

### DETAILED DESCRIPTION

Against this background, the invention provides a composition for production of polyurethane foam, especially rigid polyurethane foam, comprising at least an isocyanate component, a polyol component, optionally a catalyst that catalyzes the formation of a urethane or isocyanurate bond, optionally blowing agent, wherein this composition comprises block copolymers based on OH- or amino-functionalized polyolefins and polyesters. The block copolymers according to the invention act as foam stabilizer in the production of polyurethane foam, especially rigid PU foams.

The subject-matter of the invention enables provision of PU foam, preferably rigid PU foam, dispensing with the known siloxane-containing stabilizers. The resulting PU foams nevertheless meet the known demands. They are advantageously dimensionally stable and hydrolysis-stable and have excellent long-term characteristics. They advantageously have very good insulation properties, a very high insulation capacity, high mechanical strength, high stiffness, high compressive strength. The subject-matter of the invention also enables the provision of PU foam, preferably rigid PU foam, with use jointly with the siloxane-containing stabilizers known from the prior art.

Block copolymers based on OH- or amino-functionalized polyolefins and polyesters are known per se from the prior art. For this purpose, particular reference is made to European patent application EP 3 243 863 A1, but this relates to adhesives or sealants and neither mentions nor relates to the topic of PU foams.

When the block copolymers used according to the invention are B(A)x block systems, with A=polyester, with B=OH- or amino-functionalized polyolefins and with x≥1, preferably x=1.5 to 5, especially x=2 to 3, this is a preferred embodiment of the invention.

When the OH- or amino-functionalized polyolefin B used is a polybutadiene containing or preferably consisting of the 1,3-butadiene-derived monomer units

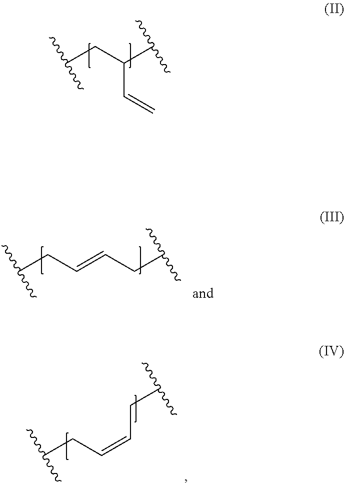

with the proviso that the monomer units (II), (III) and (IV) may be arranged in blocks or in random distribution, where a square bracket in the chosen formula representation of the 1,3-butadiene-derived monomer units (II), (III) and (IV) present in the polybutadiene shows that the bond endowed with the respective square bracket does not end with a methyl group, for instance, but that the corresponding monomer unit is bonded via this bond to a further monomer unit, a hydroxyl group or an amino group, this is a further preferred embodiment of the invention.

When the polyolefin radical B additionally includes, in a proportion of up to 5 mole per cent, based on the polybutadiene, one or more branching structures of the formula (V), (VI) or (VII)

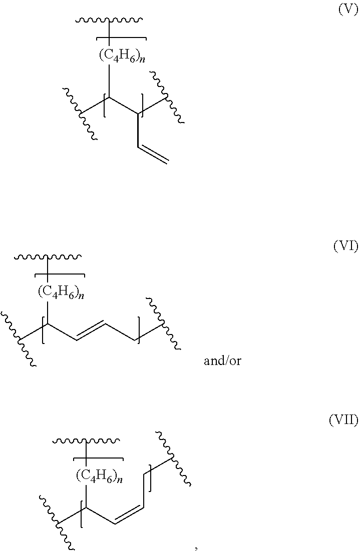

where “(C₄H₆)ₙ” corresponds to a butadiene oligomer containing or preferably consisting of the repeat units (II), (III) and (IV), this is again a further preferred embodiment of the invention.

In a further preferred embodiment of the invention, the polybutadiene is in non-hydrogenated, partly hydrogenated or fully hydrogenated form.

Suitable processes for preparing usable polybutadienes are described, for example, in EP 2 492 292. Polybutadienes usable by way of example in the context of the present invention are also commercially available, for example OH-functionalized polybutadiene in the form of POLYVEST® HT from Evonik Resource Efficiency GmbH.

As well as the OH- or amino-functionalized polyolefins, the block copolymers used in accordance with the invention contain blocks formed from polyesters; more particularly, the block copolymers are based on polyesters formed from lactones and/or lactide.

In another further preferred embodiment of the invention, the polyester radical A has the structure I:

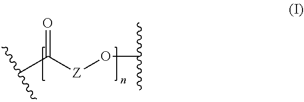

with Z=identical or different hydrocarbyl radicals, preferably —C₅H₁₀- and/or —C(CH₃)H— radical, and n=1-150.

If the block copolymers are based on polyesters of lactones and/or lactides, more preferably caprolactone and/or lactide, this is a further preferred embodiment of the invention.

Examples of suitable lactones are especially C₃ lactones such as β-propiolactone, C₄ lactones such as β-butyrolactone or γ-butyrolactone, C₅ lactones such as 4-hydroxy-3-pentenoic acid-gamma-lactone, α-methylene-γ-butyrolactone, γ-methylene-γ-butyrolactone, 3-methyl-2(5H)-furanone, γ-valerolactone, δ-valerolactone, C₆ lactones such as δ-hexalactone, ε-caprolactone or γ-hexalactone, or further lactones such as 5-butyl-4-methyldihydro-2(3H)-furanone, 6-octanolactone, γ-phenyl-ε-caprolactone, oxacyclododecan-2-one, oxacyclotridecan-2-one, pentadecanolide, 16-hexadecanolide, γ-undecalactone, δ-undecalactone, γ-methylene-γ-butyrolactone and mixtures thereof.

Lactides in the context of the present invention are understood to mean cyclic esters of lactic acid which can occur in three isomers: (S,S)-3,6-Dimethyl-1,4-dioxane-2,5-dione (CAS No. 4511-42-6), (R,R)-3,6-dimethyl-1,4-dioxane-2,5-dione (CAS No. 25038-75-9) and (meso)-3,6-dimethyl-1,4-dioxane-2,5-dione (CAS No. 13076-19-2). No isomeric form is particularly preferred here.

Preferably, the block copolymers are prepared using mixtures of at least two lactones and/or lactides, preferably mixtures of one lactone and one lactide, with especial preference for mixtures of ε-caprolactone and lactide. In this way, it is possible to vary the properties of the block copolymers in a controlled manner, especially with regard to miscibility with other polyester polyols, polyether polyols, polyether siloxanes, or with regard to the thermal properties.

The block copolymers used in accordance with the invention may especially be obtained by OH- or amino-initiated ring-opening polymerization. The OH- or amino-functionalized polymers serve here as initiator in the ring opening of the lactones and/or lactides, which leads to the formation of the polyester chains on the OH- or amino-functionalized polymer.

Standard homogeneous catalysts for the ring-opening polymerization are, for example, tin(II) ethylhexanoate, dibutyltin dilaurate, organic amidine bases such as 1,8-diazabicyclo[5.4.0]undec-7-ene, 1,5-diazabicyclo[4.3.0]non-5-ene, 1,4-diazabicyclo[2.2.2]octane and 1,5,7-triazabicyclo[4.4.0]dec-5-ene, or titanium(IV) alkoxides such as tetramethyl titanate, tetrabutyl titanate, tetraisopropyl titanate, tetraphenyl titanate, dibutyltriethanolamine titanate, tetrahexyl titanate or triethanolaminatoisopropyl titanate. The ring-opening reaction is normally conducted at temperatures of 20-250° C., especially within a period of 1-20 hours, either in the melt or in the presence of solvents. The molar ratios of lactone and/or lactide to OH- or amino-containing polymers are typically 1:1 to 200:1.

The concentration of hydroxyl end groups in the block copolymers used in accordance with the invention, determined by titrimetric means to DIN 53240-2, is preferably between 0 and 300 mg KOH/g, preferably between 5 and 50 mg KOH/g.

The number-average molecular weight of the block copolymers used in accordance with the invention is preferably 600-60 000 g/mol, especially 1000-30 000 g/mol. It is determined in accordance with DIN 55672-1 by means of gel permeation chromatography in tetrahydrofuran as eluent and polystyrene for calibration.

If the proportion by mass of the total amount of block copolymer according to the invention, based on 100 parts by mass of polyol component, is 0.1 to 10 pphp, preferably 0.5 to 5 pphp and more preferably 1 to 4 pphp, this is again a preferred embodiment of the invention.

When a composition according to the invention has the feature that the mass-weighted proportion of the polyester radical A is at least 20%, preferably at least 30%, more preferably at least 35%, this is again a preferred embodiment of the invention.

The present invention makes it possible to dispense with Si-containing foam stabilizers. In this context, compositions according to the invention that contain Si-containing foam stabilizers, based on the total amount of foam stabilizers, to an extent of less than 15% by weight, preferably less than 10% by weight, further preferably less than 5% by weight, more preferably less than 3% by weight, even more preferably less than 1% by weight, especially less than 0.5% by weight, if at all, are a preferred embodiment of the invention.

As mentioned, the present invention additionally enables the parallel use of Si-containing foam stabilizers. In this context, compositions according to the invention that contain Si-containing foam stabilizers, based on the total amount of foam stabilizers, to an extent of more than 1% by weight, preferably more than 10% by weight, especially more than 20% by weight, are a preferred embodiment of the invention. In the context of such an embodiment, for example, 50% by weight:50% by weight mixtures are also possible; in other words, the composition would comprise equal portions of the block copolymer according to the invention and also Si-containing foam stabilizers. This is because it has been found that, surprisingly, the block copolymer according to the invention greatly improves the emulsifiability of Si-containing foam stabilizers.

As well as the block copolymers according to the invention that are based on OH- or amino-functionalized polyolefins and polyesters, it is in principle additionally possible to use any of the foam-stabilizing components known from the prior art.

The block copolymers according to the invention can be used in neat form or else in a solvent. In this context, it is possible to use all suitable substances usable in the production of PU foams. Solvents used are preferably substances which are already used in standard formulations, for example OH-functional compounds, polyols, flame retardants, etc.

A preferred composition according to the invention comprises the following constituents:
a) block copolymers according to the invention, as described above,
b) at least one polyol component,
c) at least one polyisocyanate and/or polyisocyanate prepolymer,
d) optionally a catalyst which accelerates or controls the reaction of polyols b) with the isocyanates c),
e) optionally further foam stabilizers, especially corresponding silicon compounds,
f) optionally one or more blowing agents,
g) optionally further additives, fillers, flame retardants, etc.

It is preferable here that components d) and f) are obligatory.

In a preferred embodiment of the invention, the polyurethane foams are produced using, as well as the block copolymer according to the invention, a component having at least 2 isocyanate-reactive groups, preferably a polyol component, a catalyst and a polyisocyanate and/or a polyisocyanate prepolymer. The catalyst is introduced here especially via the polyol component. Suitable polyol components, catalysts and polyisocyanates and/or polyisocyanate prepolymers are well known to the person skilled in the art, but are described in more detail hereinafter.

Polyols suitable as polyol component b) for the purposes of the present invention are all organic substances having one or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, known as “natural oil-based polyols” (NOPs) which are customarily used for producing polyurethane systems, especially polyurethane coatings, polyurethane elastomers or foams. The polyols typically have a functionality of from 1.8 to 8 and number-average molecular weights in the range from 500 to 15 000. Polyols having OH values within a range from 10 to 1200 mg KOH/g are typically used.

For production of rigid PU foams, it is possible with preference to use polyols or mixtures thereof, with the proviso that at least 90 parts by weight of the polyols present, based on 100 parts by weight of polyol component, have an OH number greater than 100, preferably greater than 150, especially greater than 200. The fundamental difference between flexible foam and rigid foam is that flexible foam shows elastic characteristics and is reversibly deformable. When the flexible foam is deformed by expenditure of force, it returns to its starting shape as soon as the force ceases. By contrast, rigid foam is permanently deformed. This is well known to those skilled in the art.

Polyether polyols are obtainable by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain from 2 to 4 carbon atoms in the alkylene radical. Examples are tetrahydrofuran, 1,3-propylene oxide, 1,2-butylene oxide and 2,3-butylene oxide; ethylene oxide and 1,2-propylene oxide are preferably used. The alkylene oxides may be used individually, cumulatively, in blocks, in alternation or as mixtures. Starter molecules used may especially be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule is dependent on the respective field of application of the resulting polyether polyol in the production of polyurethane.

Polyester polyols are based on esters of polybasic aliphatic or aromatic carboxylic acids, preferably having 2-12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having 2 to 12, more preferably having 2 to 6, carbon atoms, preferably ethylene glycol, diethylene glycol, trimethylolpropane and glycerol.

In a particularly preferred embodiment of the invention, polyester polyol(s) is/are present in the composition according to the invention.

Polyether polycarbonate polyols are polyols containing carbon dioxide in the bonded form of the carbonate. Since carbon dioxide is formed as a by-product in large volumes in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower the costs for the production of polyols. Moreover, the use of CO₂ as comonomer is very environmentally advantageous, since this reaction constitutes the conversion of a greenhouse gas into a polymer. The preparation of polyether polycarbonate polyols by addition of alkylene oxides and carbon dioxide to H-functional starter substances with the use of catalysts is well known. Various catalyst systems may be used here: The first generation was that of heterogeneous zinc or aluminium salts, as described, for example, in U.S. Pat. No. 3,900,424 or 3,953,383. In addition, mono- and binuclear metal complexes have been used successfully for copolymerization of CO2 and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on renewable raw materials, natural oil-based polyols (NOPs), for production of polyurethane foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of such polyols are now available on the market from various manufacturers (WO 2004/020497, US 2006/0229375, WO 2009/058367). Polyols having a varying property profile are obtained, depending on the base raw material (e.g. soybean oil, palm oil or castor oil) and subsequent workup. A distinction may essentially be made between two groups: a) polyols based on renewable raw materials that are modified such that they may be used to an extent of 100% in the production of polyurethanes (WO 2004/020497, US 2006/0229375); b) polyols based on renewable raw materials that on account of their processing and properties are able to replace the petrochemical-based polyol only up to a certain proportion (WO 2009/058367).

A further class of usable polyols is that of the so-called filled polyols (polymer polyols). A feature of these is that they contain dispersed solid organic fillers up to a solids content of 40% or more. Usable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of useful polyols are those which are obtained as prepolymers via reaction of polyol with isocyanate in a molar ratio of preferably 100:1 to 5:1, more preferably 50:1 to 10:1.

Such prepolymers are preferably made up in the form of a solution in polymer, with the polyol preferably corresponding to the polyol used for preparing the prepolymers.

A preferred ratio of isocyanate and polyol, expressed as the index of the formulation, that is to say as stoichiometric ratio of isocyanate groups to isocyanate-reactive groups (e.g. OH groups, NH groups) multiplied by 100, in the context of this invention, is in the range from 10 to 1000, preferably 40 to 500. This is a preferred embodiment of the invention. An index of 100 represents a molar ratio of reactive groups of 1:1.

The isocyanate components c) used are preferably one or more organic polyisocyanates having two or more isocyanate functions.

Isocyanates suitable as isocyanate components for the purposes of this invention are all isocyanates containing at least two isocyanate groups. It is generally possible to use all aliphatic, cycloaliphatic, arylaliphatic and preferably aromatic polyfunctional isocyanates known per se. Isocyanates are more preferably used within a range from 60 to 200 mol %, relative to the sum total of the isocyanate-consuming components.

Specific examples are: alkylene diisocyanates having 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomeric mixtures, and preferably aromatic diisocyanates and polyisocyanates such as tolylene 2,4- and 2,6-diisocyanate (TDI) and the corresponding isomeric mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and tolylene diisocyanates (TDI). The organic diisocyanates and polyisocyanates may be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates that have been modified by the incorporation of urethane, uretdione, isocyanurate, allophanate and other groups, which are termed modified isocyanates.

Particularly suitable organic polyisocyanates that are therefore used with particular preference are various isomers of tolylene diisocyanate (tolylene 2,4- and 2,6-diisocyanate (TDI), in pure form or as isomer mixtures of varying composition), diphenylmethane 4,4′-diisocyanate (MDI), “crude MDI” or “polymeric MDI” (containing the 4,4′ isomer and also the 2,4′ and 2,2′ isomers of MDI and products having more than two rings) and also the two-ring product that is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

d) Catalysts

Suitable, optionally usable catalysts d) in the context of the present invention are all compounds capable of accelerating the reaction of isocyanates with OH functions, NH functions or other isocyanate-reactive groups. It is possible here to make use of the customary catalysts known from the prior art, including, for example, amines (cyclic, acyclic; monoamines, diamines, oligomers having one or more amino groups), organometallic compounds and metal salts, preferably those of tin, iron, bismuth and zinc. In particular, it is possible to use mixtures of a plurality of components as catalysts.

Component e) is optionally usable further foam stabilizers that are not block copolymers according to the invention. They may preferably be surface-active silicon compounds which serve to further optimize the desired cell structure and the foaming process. In the context of this invention, it is possible to use any Si-containing compounds which promote foam production (stabilization, cell regulation, cell opening, etc.). These compounds are sufficiently well known from the prior art. Surface-active Si-containing compounds may be any known compounds suitable for production of PU foam.

Siloxane structures of this type which are usable in the context of this invention are described, for example, in the following patent documents, although these describe use only in conventional polyurethane foams, as moulded foam, mattress, insulation material, construction foam, etc: CN 103665385, CN 103657518, CN 103055759, CN 103044687, US 2008/0125503, US 2015/0057384, EP 1520870 A1, EP 1211279, EP 0867464, EP 0867465, EP 0275563. These documents are hereby incorporated by reference and are considered to form part of the disclosure-content of the present invention.

The use of blowing agents f) is optional, according to which foaming process is used. It is possible to work with chemical and physical blowing agents. The choice of the blowing agent here depends greatly on the type of system.

According to the amount of blowing agent used, a foam having high or low density is produced. For instance, foams having densities of 5 kg/m³ to 900 kg/m³ can be produced. Preferred densities are 8 to 800, more preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. These blowing agents are, for example, liquefied CO₂, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFO) or hydrohaloolefins, for example 1234ze, 1233zd(E) or 1336mzz, oxygen compounds such as methyl formate, acetone and dimethoxymethane, or chlorinated hydrocarbons, preferably dichloromethane and 1,2-dichloroethane.

Optional additives g) that may be used include all substances which are known from the prior art and find use in the production of polyurethanes, preferably PU foam, especially rigid polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, color pastes, fragrances, emulsifiers etc.

Flame retardants included in the composition according to the invention may be any of the known flame retardants which are suitable for production of polyurethane foams. Suitable flame retardants for the purposes of this invention are preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Furthermore, halogenated compounds, for example halogenated polyols, and solids such as expandable graphite, aluminium oxides, antimony compounds and melamine are suitable as flame retardants. The inventive use of the block copolymers enables the use of very high amounts of flame retardant, especially also liquid flame retardants, for example TEP, TCPP, TCEP, DMMP, which normally leads to comparatively unstable formulations.

The invention further provides a process for producing polyurethane foam, especially rigid polyurethane foam, by reacting one or more polyol components with one or more isocyanate components, wherein the reaction is effected in the presence of a block copolymer according to the invention, based on OH- or amino-functionalized polyolefins and polyesters, especially using a composition according to the invention as described above. In order to avoid repetition, reference is made in this regard to the preceding text. Especially with regard to preferred embodiments of the invention, reference is made to the preceding text. The block copolymers according to the invention act as foam stabilizer.

The foams to be produced in accordance with the invention, especially rigid PU foams, have densities of preferably 5 kg/m³ to 900 kg/m³, more preferably 8 to 800, especially preferably 10 to 600 kg/m³, more particularly 20 to 150 kg/m³.

More particularly, it is possible to obtain closed-cell PU foams, preferably rigid PU foams, wherein the closed-cell content is advantageously >80%, preferably >90%. This is a very particularly preferred embodiment of the invention. The closed-cell content, in the context of this invention, is preferably determined to DIN ISO 4590 by pycnometer.

The process according to the invention for producing PU foams can be conducted by the known methods, for example by manual mixing or preferably by means of foaming machines. If the process is carried out by using foaming machines, it is possible to use high-pressure or low-pressure machines. The process according to the invention can be carried out either batchwise or continuously.

A preferred rigid polyurethane or polyisocyanurate foam formulation according to the present invention gives a foam density of from 5 to 900 kg/m³ and has the composition shown in Table 1.

TABLE 1
Composition of a preferred rigid polyurethane
or polyisocyanurate foam formulation

| Component | Proportion by weight |
|---|---|
| Block copolymers according to the invention | >0.5 to 5 |
| Polyol | >0 to 99.9 |
| Amine catalyst | 0 to 5 |
| Metal catalyst | 0 to 10 |
| Polyether siloxane | 0 to 5 |
| Water | 0.01 to 20 |
| Blowing agent | 0 to 40 |
| Further additives (flame retardants, etc.) | 0 to 300 |
| Isocyanate index: 10 to 1000 | |

For further preferred embodiments and configurations of the process of the invention, reference is also made to the details already given above in connection with the composition of the invention, especially to the preferred embodiments specified there.

The present invention further provides a polyurethane foam, preferably rigid PU foam, obtainable by the process mentioned.

A preferred embodiment concerns a rigid polyurethane foam having a foam density of 5 to 750 kg/m³, preferably of 5 to 350 kg/m³.

In a further preferred embodiment of the invention, the polyurethane foam, preferably rigid PU foam, has a foam density of 5 to 900 kg/m³, more preferably 8 to 800, especially preferably 10 to 600 kg/m³, more particularly 20 to 150 kg/m³, and the closed-cell content is advantageously >80%, preferably >90%.

It is advantageously a feature of the polyurethane foams according to the invention that they include at least one block copolymer according to the invention, as described above, and are preferably obtainable by the process according to the invention.

The PU foams according to the invention (polyurethane or polyisocyanurate foams), especially rigid PU foams, can be used as or for production of insulation materials, preferably insulation boards, refrigerators, insulating foams, vehicle seats, especially automobile seats, roof liners, mattresses, filter foams, packaging foams or spray foams.

The PU foams according to the invention, especially rigid PU foams, can be used advantageously particularly in the refrigerated warehouse, refrigeration appliances and domestic appliances industry, for example for production of insulating panels for roofs and walls, as insulating material in containers and warehouses for frozen goods, and for refrigeration and freezing appliances.

Further preferred fields of use are in vehicle construction, especially for production of vehicle inner roof liners, bodywork parts, interior trim, cooled vehicles, large containers, transport pallets, packaging laminates, in the furniture industry, for example for furniture parts, doors, linings, in electronics applications.

Cooling apparatuses of the invention have, as insulation material, a PU foam according to the invention (polyurethane or polyisocyanurate foam), especially rigid PU foam.

The invention further provides for the use of the PU foam, especially rigid PU foam, as insulation material in refrigeration technology, in refrigeration equipment, in the construction sector, automobile sector, shipbuilding sector and/or electronics sector, as insulating panels, as spray foam, as one-component foam.

The invention further provides for the use of block copolymers according to the invention, as described above, in the production of PU foams, especially rigid PU foams, preferably as foam stabilizer, more preferably for improving the insulation properties of the foam, especially using a composition according to the invention as described above.

The subject matter of the invention is described by way of example above or hereinafter, without any intention that the invention be restricted to these illustrative embodiments. Where ranges, general formulae or compound classes are specified above or hereinafter, these are intended to include not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, percentages are in per cent by weight. Where averages are reported above or hereinafter, these are weight averages unless stated otherwise. Where parameters that have been determined by measurement are given above or hereinafter, the measurements have been conducted at a temperature of 25° C. and a pressure of 101 325 Pa, unless stated otherwise.

The examples that follow describe the present invention by way of example, without any intention that the invention, the scope of application of which is apparent from the entirety of the description and the claims, be restricted to the embodiments specified in the examples.

### EXAMPLES

### Example 1

Synthesis of the Block Copolymers Based on OH- or Amino-Functionalized Polyolefins and Polyesters

Synthesis of Block Copolymer 1

225 g of POLYVEST® HT (hydroxy-terminated polybutadiene from Evonik Resource Efficiency GmbH) is blended with 525 g of ε-caprolactone and 0.75 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 6300 g/mol at a PDI of 3.7; the DSC analysis gives a melting point Tₘ of 54.3° C. and a glass transition point T_{g} of −74.0° C. The OH number of the polymer is 17 mg KOH/g of polymer.

Synthesis of Block Copolymer 2

450 g of POLYVEST® HT is blended with 750 g of ε-caprolactone, 300 g of lactide and 1.50 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 7500 g/mol at a PDI of 3.0; the DSC analysis gives two glass transition points T_{g}i of −82.2° C. and T_{g2} of −50.4° C. The OH number of the polymer is 17 mg KOH/g of polymer.

Synthesis of Block Copolymer 3

750 g of POLYVEST® HT is blended with 375 g of ε-caprolactone, 375 g of lactide and 1.50 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 6600 g/mol at a PDI of 2.4; the DSC analysis gives two glass transition points T_{g1} of −79.5° C. and T_{g2} of −38.7° C. The OH number of the polymer is 26 mg KOH/g of polymer.

Synthesis of Block Copolymer 4

750 g of POLYVEST® HT is blended with 600 g of ε-caprolactone, 150 g of lactide and 1.50 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 7000 g/mol at a PDI of 2.4; the DSC analysis gives a melting point Tₘ of 19.8° C. and a glass transition point T_{g} of −71.0° C. The OH number of the polymer is 27 mg KOH/g of polymer.

Synthesis of Block Copolymer 5

750 g of Nisso GI1000 (hydroxy-terminated polybutadiene from Nippon Soda Co Ltd.) is blended with 600 g of ε-caprolactone, 150 g of lactide and 1.50 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 4000 g/mol at a PDI of 1.8; the DSC analysis gives a melting point Tₘ of 24.6° C. and two glass transition points T_{g1} of −60.4° C. and T_{g2} of −47.9° C. The OH number of the polymer is 34 mg KOH/g of polymer.

Synthesis of Block Copolymer 6

600 g of POLYVEST® HT is blended with 720 g of ε-caprolactone, 180 g of lactide and 1.50 g of a titanium catalyst under a nitrogen stream in a 2 liter multineck flask with reflux condenser. Subsequently, the mixture is heated under a constant nitrogen stream while stirring to 160° C. for 6 hours. The GPC analysis of the block copolymer gives an average molecular weight Mn of 7300 g/mol at a PDI of 2.6; the DSC analysis gives a melting point Tₘ of 22.4° C. and a glass transition point T_{g} of −68.8° C. The OH number of the polymer is 22 mg KOH/g of polymer.

The number-average molecular weight of the block copolymers according to the invention is determined in accordance with DIN 55672-1 by means of gel permeation chromatography in tetrahydrofuran as eluent and polystyrene for calibration.

The thermal properties of the block copolymers used in the context of the present invention are determined by differential scanning calorimetry (DSC) in accordance with the DSC method DIN 53765. The values for the second heating interval are reported. The heating rate was 10 K/min. The concentration of the OH groups (OH number) is determined in accordance with DIN 53240-2 by titrimetry in mg KOH/g of polymer.

### Example 2: Rigid PUR Foam

The following foam formulation was used for the performance comparison:

| Component | Proportion by weight |
|---|---|
| Polyether polyol* | 100 |
| Catalyst** | 2 |
| Surfactant*** | 2 |
| Water | 1 |
| Cyclopentane | 14 |
| MDI**** | 193 |

*Daltolac ® R 471 from Huntsman, OH number 470 mg KOH/g
**POLYCAT ® 8 from Evonik Industries AG
***Block copolymers as described in Example 1 or TEGOSTAB ® B 8491 from Evonik Industries AG
****Polymeric MDI, 200 mPa*s, 31.5% NCO, functionality 2.7.

The comparative foamings were carried out by hand mixing. For this purpose, polyol, catalysts, water, foam stabilizer and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, the reaction mixture was stirred with the stirrer described at 2500 rpm for 7 s and immediately transferred into an open mould having a size of 27.5×14×14 cm (W×H×D).

After 10 min, the foams were demoulded. One day after foaming, the foams were analyzed. The pore structure was assessed subjectively on a scale from 1 to 10, where 10 represents an (idealized) impeccable, very fine foam and 1 represents a very significantly defective, coarse foam.

The results are compiled in the table which follows:

| Surfactant | Rating |
|---|---|
| TEGOSTAB B 8491 | 7.0 |
| Block copolymer 1 | 6.0 |
| Block copolymer 2 | 6.0 |
| Block copolymer 3 | 7.0 |
| Block copolymer 4 | 7.0 |
| Block copolymer 5 | 7.5 |

The results show that it is possible with block copolymers 3 to 5 in particular to achieve pore structures and foam qualities that are at the same level as or slightly better than siloxane-based cell stabilizers.

All other application-relevant foam properties are only insignificantly affected, if at all, by the block copolymers according to the invention.

### Example 3: Rigid PIR Foam

The following foam formulation was used for the performance comparison:

| Component | Proportion by weight |
|---|---|
| Polyester polyol* | 100 |
| Amine catalyst** | 0.6 |
| Potassium trimerization catalyst*** | 4 |
| Surfactant**** | 2 |
| Water | 1 |
| Cyclopentane | 16 |
| MDI***** | 199 |

*Stepanpol ® PS 2352 from Stepan, OH number 250 mg KOH/g
**POLYCAT ® 5 from Evonik Industries AG
***KOSMOS ® 75 from Evonik Industries AG
****Block copolymers as described in Example 1 or TEGOSTAB ® B 8491 from Evonik Industries AG
*****Polymeric MDI, 200 mPa*s, 31.5% NCO, functionality 2.7.

The comparative foamings were carried out by hand mixing. For this purpose, polyol, catalysts, water, foam stabilizer, flame retardant and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, the reaction mixture was stirred with the stirrer described at 3000 rpm for 5 s and immediately transferred into an open mould having a size of 27.5×14×14 cm (W×H×D).

After 10 min, the foams were demoulded. One day after foaming, the foams were analyzed. The pore structure was assessed subjectively on a scale from 1 to 10, where 10 represents an (idealized) impeccable, very fine foam and 1 represents a very significantly defective, coarse foam.

The results are compiled in the table which follows:

| Surfactant | Rating |
|---|---|
| TEGOSTAB B 8491 | 7.5 |
| Block copolymer 1 | 7.5 |
| Block copolymer 2 | 8.0 |
| Block copolymer 3 | 6.5 |
| Block copolymer 4 | 7.0 |
| Block copolymer 5 | 6.0 |

The results show that it is possible with block copolymers 1 and 2 in particular to achieve pore structures and foam qualities that are at the same level as or slightly better than siloxane-based cell stabilizers.

All other application-relevant foam properties are only insignificantly affected, if at all, by the block copolymers according to the invention.

### Example 4: Rigid PIR Foam

The following foam formulation was used for the performance comparison:

| Component | Proportion by weight |
|---|---|
| Polyester polyol* | 100 |
| Amine catalyst** | 0.6 |
| Potassium trimerization catalyst*** | 4 |
| Surfactant**** | 4 |
| Water | 0.8 |
| Cyclo-/iso-pentane 70:30 | 16 |
| TCPP | 15 |
| MDI***** | 230 |

*Stepanpol ® PS 2352 from Stepan, OH number 250 mg KOH/g
**POLYCAT ® 5 from Evonik Industries AG
***KOSMOS ® 75 from Evonik Industries AG
****Block copolymers as described in Example 1 or TEGOSTAB ® B 8871 from Evonik Industries AG
*****Polymeric MDI, 200 mPa*s, 31.5% NCO, functionality 2.7.

The comparative foamings were carried out by hand mixing. For this purpose, polyol, catalysts, water, foam stabilizer, flame retardant and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, and the reaction mixture was stirred with the stirrer described at 3000 rpm for 5 s and immediately transferred into a 25 cm×50 cm×7 cm aluminium mould lined with polyethylene film and thermostatted to 60° C.

After 10 min, the foams were demoulded. One day after foaming, the foams were analyzed. Surface and internal defects were assessed subjectively on a scale from 1 to 10, where 10 represents an (idealized) impeccable foam and 1 represents a very significantly defective foam. The thermal conductivity coefficient (λ value in mW/m·K) was measured on 2.5 cm-thick discs with a device of the Hesto Lambda Control type, model HLC X206, at an average temperature of 10° C. in accordance with the specifications of standard EN12667:2001.

The results are compiled in the table which follows:

| | | Thermal | | | | |
|---|---|---|---|---|---|---|
| | Density | conduc- | Front | Reverse | | Pore |
| | in | tivity in | side | side | Internal | struc- |
| Surfactant | kg/m³ | mW/mK | surface | surface | defects | ture |
| TEGOSTAB | 47.5 | 22.1 | 6.0 | 7.0 | 7.0 | 8.0 |
| B 8871 | | | | | | |
| Block | 48.6 | 22.0 | 7.0 | 6.0 | 6.0 | 8.0 |
| copolymer 2 | | | | | | |
| Block | 45.8 | 22.1 | 7.0 | 7.0 | 7.0 | 7.0 |
| copolymer 4 | | | | | | |

The results show that it is possible with the block copolymers to achieve foam qualities and thermal conductivities that are at the same level as or slightly better than siloxane-based cell stabilizers.

All other application-relevant foam properties are only insignificantly affected, if at all, by the block copolymers according to the invention.

### Example 5: Rigid PIR Foam

The following foam formulation was used for the performance comparison:

| Component | Proportion by weight |
|---|---|
| Polyester polyol* | 100 |
| Amine catalyst** | 0.4 |
| Potassium trimerization catalyst*** | 5 |
| Surfactant**** | 2 |
| Water | 0.4 |
| Cyclo-/iso-pentane 70:30 | 21 |
| TCPP | 10 |
| MDI***** | 202 |

*Stepanpol ® PS 2412 from Stepan, OH number 240 mg KOH/g
**POLYCAT ® 5 from Evonik Industries AG
***KOSMOS ® 70 LO from Evonik Industries AG
****Block copolymers as described in Example 1 or TEGOSTAB ®B 8871 from Evonik Industries AG
*****Polymeric MDI, 200 mPa*s, 31.5% NCO, functionality 2.7.

The comparative foamings were carried out by hand mixing. For this purpose, polyol, catalysts, water, foam stabilizer, flame retardant and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, and the reaction mixture was stirred with the stirrer described at 3000 rpm for 5 s and immediately transferred into a 25 cm×50 cm×7 cm aluminium mould lined with polyethylene film and thermostatted to 60° C.

After 10 min, the foams were demoulded. One day after foaming, the foams were analyzed. Surface and internal defects were assessed subjectively on a scale from 1 to 10, where 10 represents an (idealized) impeccable foam and 1 represents a very significantly defective foam. The thermal conductivity coefficient (λ value in mW/m·K) was measured on 2.5 cm-thick discs with a device of the Hesto Lambda Control type, model HLC X206, at an average temperature of 10° C. in accordance with the specifications of standard EN12667:2001.

The results are compiled in the table which follows:

| | | Thermal | | | | |
|---|---|---|---|---|---|---|
| | Density | conduc- | Front | Reverse | | Pore |
| | in | tivity in | side | side | Internal | struc- |
| Surfactant | kg/m³ | mW/mK | surface | surface | defects | ture |
| TEGOSTAB | 37.5 | 23.3 | 4.5 | 5.0 | 7.0 | 7.0 |
| B 8871 | | | | | | |
| Block | 36.9 | 23.5 | 5.0 | 5.0 | 6.5 | 6.5 |
| copolymer 2 | | | | | | |
| Block | 35.8 | 23.5 | 5.0 | 6.0 | 6.5 | 7.0 |
| copolymer 6 | | | | | | |

The results show that it is possible with the block copolymers to achieve foam qualities and thermal conductivities that are at the same level as siloxane-based cell stabilizers.

All other application-relevant foam properties are only insignificantly affected, if at all, by the block copolymers according to the invention.

1. A composition for production of polyurethane foam, comprising an isocyanate component, a polyol component, optionally a catalyst that catalyzes the formation of a urethane or isocyanurate bond, optionally blowing agent, wherein the composition comprises block copolymers based on OH- or amino-functionalized polyolefins and polyesters.

2. The composition according to claim 1, wherein the block copolymers are B(A)x block systems with A=polyester, with B=OH- or amino-functionalized polyolefins and with x≥1.

3. The composition according to claim 2, wherein the OH- or amino-functionalized polyolefin B used is a polybutadiene consisting of the 1,3-butadiene-derived monomer units 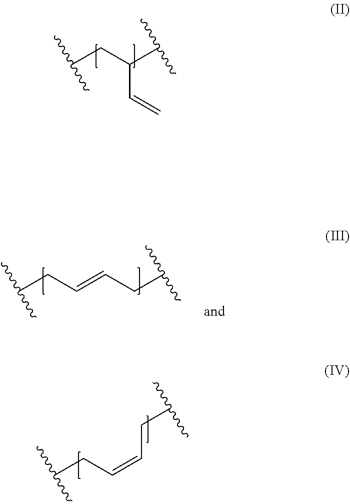
wherein the monomer units (II), (III) and (IV) may be arranged in blocks or in random distribution, where a square bracket in the chosen formula representation of the 1,3-butadiene-derived monomer units (II), (III) and (IV) present in the polybutadiene shows that the bond endowed with the respective square bracket does not end with a methyl group, for instance, but that the corresponding monomer unit is bonded via this bond to a further monomer unit, a hydroxyl group or an amino group.

4. The composition according to claim 3, wherein the polyolefin radical B additionally includes, in a proportion of up to 5 mole per cent, based on the polybutadiene, one or more branching structures of the formula (V), (VI) or (VII) 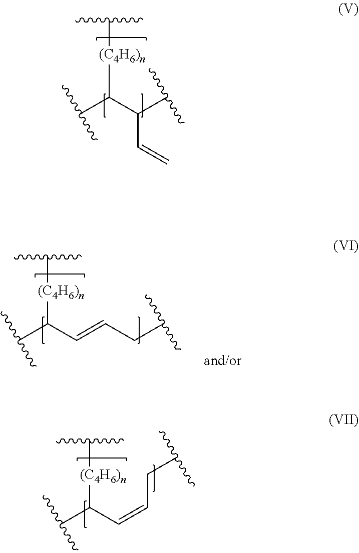
where “(C₄H₆)ₙ” corresponds to a butadiene oligomer consisting of the repeat units (II), (III) and (IV).

5. The composition according to claim 3, wherein the polybutadiene is in non-hydrogenated, partly hydrogenated or fully hydrogenated form.

6. The composition according to claim 2, wherein the polyester residue A has the structure I: 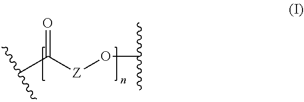
with Z=identical or different hydrocarbyl radicals, and n=1-150.

7. The composition according to claim 1, wherein the block copolymers are based on polyesters made from lactones and/or lactides.

8. The composition according to claim 1, wherein the proportion by mass of the total amount of block copolymer according to the invention, based on 100 parts by mass of polyol component, is from 0.1 to 10 pphp.

9. The composition according to claim 1, wherein Si-containing foam stabilizers, based on the total amount of foam stabilizers, also including the block copolymers according to the invention that are based on OH- or amino-functionalized polyolefins and polyesters, are present to an extent of less than 15% by weight.

10. The composition according to claim 1, wherein Si-containing foam stabilizers, based on the total amount of foam stabilizers, also including the block copolymers according to the invention that are based on OH- or amino-functionalized polyolefins and polyesters, are present to an extent of more than 10% by weight.

11. The composition according to claim 2, wherein the mass-weighted proportion of the polyester residue A is at least 20%.

12. The process for producing polyurethane foam, by reacting one or more polyol components with one or more isocyanate components, wherein the reaction is effected in the presence of a block copolymer based on OH- or amino-functionalized polyolefins and polyesters, using a composition according to claim 1.

13. A composition of block copolymers based on OH- or amino-functionalized polyolefins and polyesters in the production of rigid polyurethane foams, for improving insulation properties of the foam, for a composition according to claim 1.

14. The rigid polyurethane foam obtained by a process according to claim 12.

15. An insulation board comprising the rigid polyurethane foam according to claim 14.

16. The composition according to claim 1, wherein the block copolymers are B(A)x block systems with A=polyester, with B=OH- or amino-functionalized polyolefins and with x=from 1.5 to 5.

17. The composition according to claim 1, wherein the block copolymers are B(A)x block systems with A=polyester, with B=OH- or amino-functionalized polyolefins and with x=from 2 to 3.

18. The composition according to claim 2, wherein the polyester residue A has the structure I: 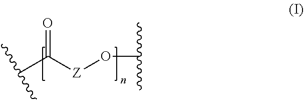
with Z=−C₅H₁₀- and/or —C(CH₃)H— radical, and n=1-150.

19. The composition according to claim 1, wherein the block copolymers are based on polyesters made from caprolactone and/or lactide.

20. The composition according to claim 1, wherein the proportion by mass of the total amount of block copolymer according to the invention, based on 100 parts by mass of polyol component, is from 0.5 to 5 pphp.
